(19) United States
(12) Patent Application Publication
(10) Pub. No.: US 2002/0088106 A1
(43) Pub. Date: Jul. 11, 2002

(54) Device for positioning a component receptacle unit of an automatic placement machine for printed circuit boards

(75) Inventor: Martin Pruefer, Muenchen (DE)

Correspondence Address: BAKER BOTTS L.L.P., 44TH FLOOR, 30 ROCKEFELLER PLAZA, NEW YORK, NY, 10112-4498, US

(73) Assignee: Siemens Dematic AG

(21) Appl. No.: 09/887,294

(22) Filed: Jun. 22, 2001

(30) Foreign Application Priority Data
Jan. 9, 2000 (DE) 101 006 19.5

(51) Int. Cl. H01S 4/00

(52) U.S. Cl. 29/592.1

(57) ABSTRACT

The rotary positioning of a suction pipette (5) serving for receiving a component (8) takes place with the aid of an incremental encoder arrangement essentially comprising a stationary read head and a rotatable segmental disk (9) which has an incremental track (10) for measuring a traversed angle of rotation for the fine positioning and also one of two full tracks (12a, 12b) arranged in opposite quadrants (11a, 11c) of the segmental disk (9) and serving for rapid movement into an initial position of the suction pipette (5) for receiving a component (8). According to the invention, to supplement the full tracks (12a, 12b) the segmental disk (9) is in this case provided with an additional marking (13a; 13b′, 13b″; 13c) in order to ensure, by means of the incremental encoder arrangement, a reproducible angular orientation of the suction pipette (5) with respect to the initial position. (in this respect, FIG. 3a)

The present invention relates to a device for positioning the component receptacle unit of an automatic placement machine for printed circuit boards, in which the rotary positioning of a suction pipette serving for receiving a component takes place with the aid of an incremental encoder arrangement essentially comprising a stationary read head and a rotatable segmental disk which has an incremental track for measuring a traversed angle of rotation for the fine positioning and also one of two full tracks arranged in opposite quadrants of the segmental disk and serving for rapid movement into an initial position of the suction pipette for receiving a component.

In a generally known manner, in an automatic placement machine of the type of interest here, an electronic component is transported by means of a component receptacle unit which takes a component from a component storage unit to a printed circuit board to be populated by means of at least one suction pipette which can be moved by means of a center sleeve. The component receptacle unit comprises, for example, a 6- or 12-segment turret head with horizontal axis of rotation which is fitted to a portal axle system with linear motors in order to perform printed circuit board population according to the Collect&Place principle. In addition, component receptacle units are also known which operate sequentially according to the Pick&Place principle and are mainly used for the placement of relatively large components.

In a device of the generic type, rotary positioning of the suction pipette is effected with the aid of an incremental encoder arrangement. The associated segmental disk has an incremental track via which the angular increments passing through can be determined by means of an encoder. This track information is used for incremental positioning. Furthermore, an inner full track arranged in opposite quadrants of the segmental disk is provided, i.e. in this respect there are additionally two opposite circle-arc segments each of 90°. These two circle-arc segments are used for rapid preliminary rotation into the desired initial position of the suction pipette for collecting a component. On account of this arrangement of the full track, the collection orientation of the suction pipette can vary at an angle of +/−180°, since only the range from 0° to 180° is defined and the remaining range from 180° to 360° is again interpreted as range from 0° to 180°. With axially symmetrical suction pipettes and an ideally oriented center sleeve, this positional interpretation is acceptable, and for technical reasons relating to signal processing, enables particularly rapid preliminary rotation of the suction pipette.

In the course of increasing miniaturization of the components, however, dimensional tolerances on elements of the component receptacle unit come to the fore to a greater extent. In particular when collecting a small component (e.g. GF 0201), from the component storage unit, the suction pipette must be positioned precisely relative to the small component.

As has been shown in practice, positional and dimensional accuracy deviations in the region of the suction pipette lead, with increasing miniaturization of the components, to a rising error rate during collection. Thus, deviations specifically occur in the axial symmetry between the suction pipette and the center sleeve, for example due to center sleeve flexure, a suction pipette that is not tightly fitted, or on account of production tolerances of the suction pipette or the like. It is also not possible to rule out the segmental disk having a slight degree of flexure. For all these reasons the axis of the suction pipette and the optical axis of rotation may diverge in such a way that, in the event of variation of the angular orientation of the suction pipette by +/−180°, it is no longer possible for a small component to be reliably received.

WO 99/49713 discloses a method and an apparatus for determining the position of a component with respect to the suction pipette of a component receptacle unit. In this case, however, with the aid of an optical sensor in interaction with a light source, it is only after the component has been collected that its presence can be determined on the suction pipette in order to be able to identify a receiving process that has not taken place correctly.

By contrast, the object of the present invention is to provide a device for determining the position of the suction pipette of a component receptacle unit which, as early as during collection of the component, permits a reproducible angular orientation in order to enable precise positioning of the suction pipette.

Proceeding from a device in accordance with the preamble of claim 1, the object is achieved in conjunction with the characterizing features of claim 1. The subsequent dependent claims represent advantageous developments of the invention.

The invention includes the technical teaching that to supplement the full tracks the segmental disk of the generic type is provided with an additional marking in order to ensure, by means of the incremental encoder arrangement, a reproducible angular orientation of the suction pipette with respect to the initial position for receiving the component.

The advantage resides in particular in the additional information—obtained in a simple manner by the additional marking—for unambiguous positioning of the suction pipette. It is now possible, during rapid movement into the initial position of the suction pipette, to discriminate the angular position in the entire range from 0° to 360°. With the reproducible collection orientation of the suction pipette that is thus obtained, positional and dimensional accuracy deviations in the region of the suction pipette can be taken into account during positioning, with the result that a lower error rate can be obtained during the collection of a small component, in particular.

According to the invention, the additional marking can be fitted on the segmental disk in three preferred embodiments. Thus, it is conceivable for the additional marking to be designed in the form of a third track which runs next to the two full tracks at a radial distance and runs over a quadrant adjacent to the two opposite quadrants. The tracks may be designed for example in circle-arc form as a thick line or else occupy an entire circle segment. However, since only information in the boundary region with respect to an adjacent quadrant is required in order to ensure a reproducible angular orientation, it also suffices if the additional marking is designed only in the form of two track parts which run next to the two full tracks at a radial distance and in each case run only over the boundary region of a quadrant adjacent to the two opposite quadrants. The track parts may be designed in line form, in point form, in elliptical form or in another suitable manner.

In the two aforementioned embodiments, owing to the radial distance with respect to the full tracks, the additional marking can be masked out from the signal processing, with the result that operation is optionally possible either with reproducible angular orientation or without the latter. Since, in the case of relatively large components, the positional and dimensional accuracy deviations in the region of the suction pipette are not critical to the same extent as in the case of small components, comparatively more rapid operation without reproducible angular orientation can be chosen, in this case, too.

According to a last preferred embodiment, the additional marking may also be designed as a track part which connects the two full tracks across an adjacent quadrant. In this respect, a continuous track is produced having an angle of 270° or—seen in inverted fashion—of 90°. In this case, although it is not possible to mask out the angular orientation information owing to the lack of a radial distance with respect to the two opposite full tracks, nonetheless there is no need for any changes on the read head through addition of a third track sensor as a result of this variant, so that existing component receptacle units can be converted at no great expense to a reproducible angular orientation by simple conversion of the signal processing software.

In order to obtain high positioning accuracy, it is advantageous if the two full tracks together with the additional markings are arranged on a smaller radius of the segmental disk with respect to the incremental track. This makes it possible to ensure a maximum resolution for the incremental track.

Further measures which improve the invention are presented in greater detail below together with the description of preferred exemplary embodiments of the invention with reference to the figures, in which:

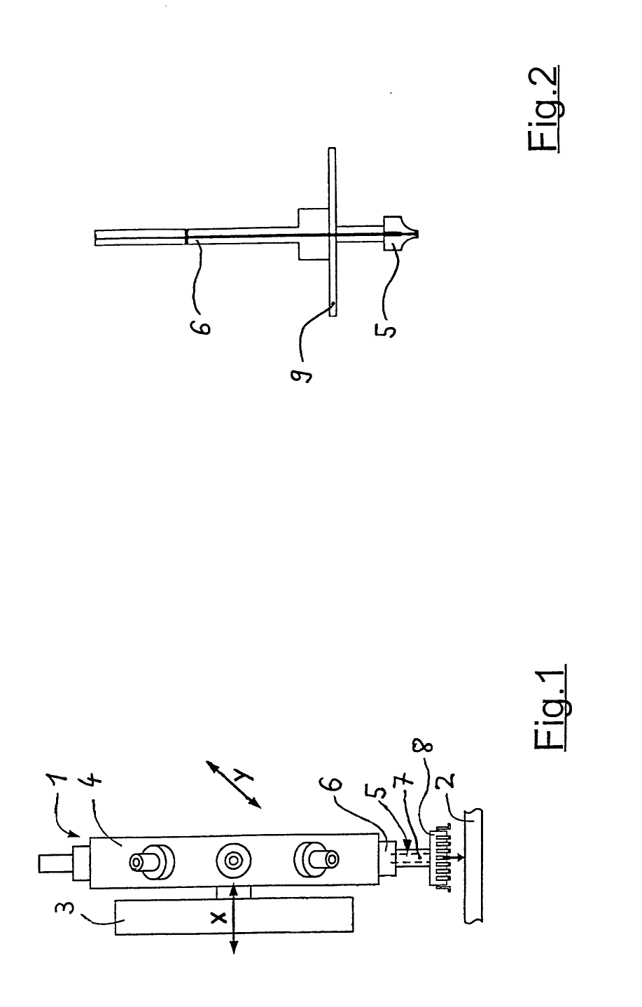

FIG. 1 shows a side view of a component receptacle unit of an automatic placement machine which can be positioned according to the invention,

FIG. 2 shows a side view of a suction pipette arranged on a center sleeve,

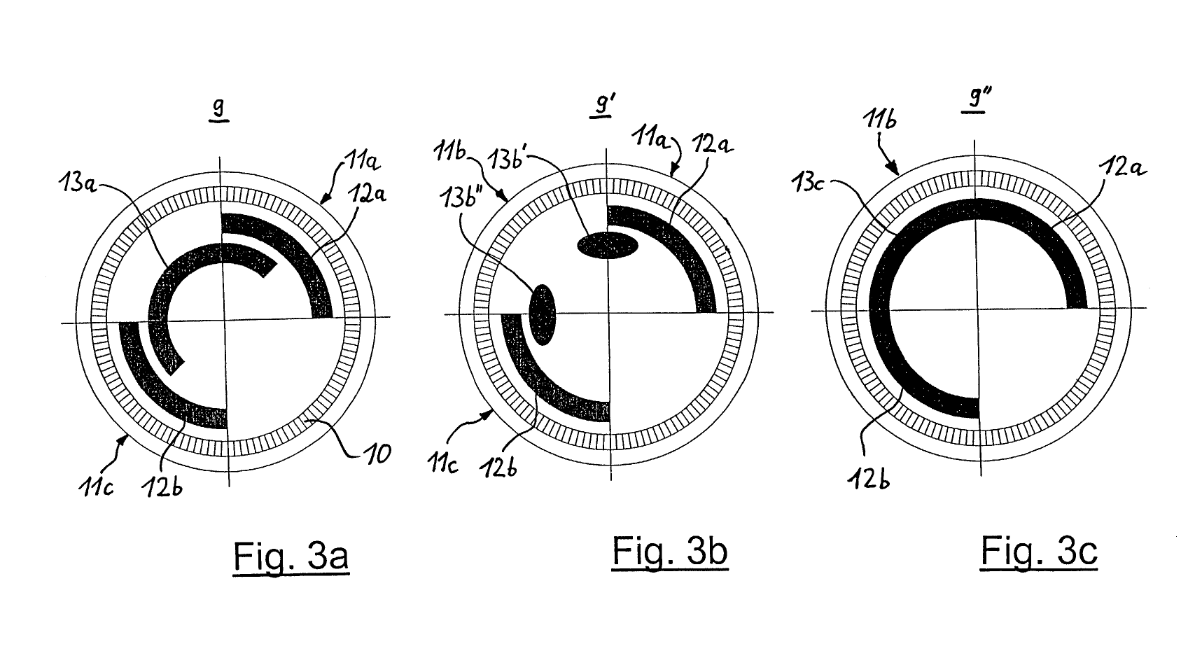

FIG. 3a shows a plan view of a first embodiment of a segmental disk designed according to the invention.

FIG. 3b shows a plan view of a second embodiment of a segmental disk designed according to the invention.

FIG. 3c shows a plan view of a third embodiment of a segmental disk designed according to the invention.

In accordance with the exemplary embodiment according to FIG. 1, a component receptacle unit 1 of an automatic placement machine for printed circuit boards 2 is designed in the manner of a 12-segment turret head with horizontal axis of rotation which can be moved on a portal axle system (not specifically shown) in the X- and Y-direction. The component receptacle unit 1 comprises a stator 3, which is connected to the portal axle system, and a rotor 4, which is mounted rotatably on said stator. The rotor 4 has suction pipettes 5 which project in a star-shaped manner and are held in a manner that allows them to be exchanged by center sleeves 6, arranged rotationally symmetrically. The suction pipette 5 holds a component 8 by suction, by means of an air duct 7, running longitudinally on the inside, in order to transport said component. The components 8 collected by the suction pipettes 5 of the rotor 4 can be rotated by means of indexed rotation of the rotor 4 in accordance with the segmental division progressively into their respective emplacement position above the printed circuit board 2. An incremental encoder arrangement is provided for the individual rotary positioning of each suction pipette 5 about its own axis.

In accordance with FIG. 2, the incremental encoder arrangement comprises a rotatable segmental disk 9, which is fitted coaxially to the center sleeve 6. The segmental disk 9 interacts with a read head (not specifically illustrated here) in order to perform the positioning of the suction pipette 5. The center sleeve 6 is part of the rotor 4 and serves for the fixing and longitudinal and also rotary movement of the suction pipette 5.

In accordance with FIG. 3a, the segmental disk 9 has an incremental track 10 for measuring a traversed angle of rotation for the fine positioning and also one of two full tracks 12a, 12b arranged in opposite quadrants 11a, 11c of the segmental disk 9 and serving for rapid rotary movement into an initial position of the suction pipette 5 for receiving a component. Furthermore, to supplement the full tracks 12a, 12b the segmental disk 9 is provided with an additional marking 13a in order to ensure, by means of the incremental encoder arrangement, a reproducible angular orientation of the suction pipette 5 with respect to the initial position.

As an alternative to this, according to FIG. 3b, the segmental disk 9′ may also be designed with an additional marking 13b′ and 13b″ in the form of two track parts which run next to the two full tracks 12a and 12b at a radial distance. In this case, the track parts in each case run only over the boundary region of a quadrant 11b adjacent to the opposite quadrants 11a, 11c.

According to a further embodiment in accordance with FIG. 3c, on the segmental disk 9″ the additional marking 13c is designed in the form of a track part which connects the two full tracks 12a and 12b across an adjacent quadrant 11b. This track part runs at the same radial distance with respect to the full tracks 12a and 12b, thus forming overall a solid three-quarter circle.

The embodiment of the present invention is not restricted to the exemplary embodiments that are specified above only as preferences. Rather, modifications thereof are also conceivable which, despite a different configuration, engage within the scope of protection of the present invention. In particular, the invention is not restricted to the design of the additional marking on the segmental disk, which design is specified only by way of example.

1. A device for positioning the component receptacle unit (1) of an automatic placement machine for printed circuit boards (2), in which the rotary positioning of a suction pipette (5) serving for receiving a component (8) takes place with the aid of an incremental encoder arrangement essentially comprising a stationary read head and a rotatable segmental disk (9) which has an incremental track (10) for measuring a traversed angle of rotation for the fine positioning and also one of two full tracks (12a, 12b) arranged in opposite quadrants (11a, 11c) of the segmental disk (9) and serving for rapid movement into an initial position of the suction pipette (5) for receiving a component (8),
characterized
in that, to supplement the full tracks (12a, 12b) the segmental disk (9) is provided with an additional marking (13a; 13b′, 13b″; 13c) in order to ensure, by means of the incremental encoder arrangement, a reproducible angular orientation of the suction pipette (5) with respect to the initial position.

2. The device as claimed in claim 1,
characterized
in that the additional marking (13a) is designed in the form of a third track which runs next to the two full tracks (12a, 12b) at a radial distance and runs over a quadrant (11b) adjacent to the two opposite quadrants (11a, 11c) (FIG. 3a).

3. The device as claimed in claim 1,
characterized
in that the additional marking (13b′ and 13b″) is designed in the form of two track parts which run next to the two full tracks (12a, 12b) at a radial distance and in each case run only over the boundary region of a quadrant (11b) adjacent to the two opposite quadrants (11a, 11c) (FIG. 3b).

4. The device as claimed in claim 1,
characterized
in that the additional marking (13c) is designed in the form of a track part which connects the two full tracks (12a, 12b) across an adjacent quadrant (11b) and runs at the same radial distance with respect to the full tracks (12a, 12b) (FIG. 3c).

5. The device as claimed in claim 1
characterized
in that the two full tracks (12a, 12b) and also the additional marking (13a; 13b′, 13b″; 13c) are arranged on a smaller radius of the segmental disk (9) with respect to the incremental track (10).
